(19) United States
(12) Patent Application Publication
(10) Pub. No.: US 2026/0298004 A1
(43) Pub. Date: Oct. 1, 2026

(54) ADJUSTABLE SELF-CLOSING ANTI-LIGATURE HINGE

(71) Applicant: ABH MANUFACTURING INC., Itasca, IL (US)

(72) Inventor: Tomasz WISZNIEWSKI, Arlington Heights, IL (US)

(21) Appl. No.: 19/096,167

(22) Filed: Mar. 31, 2025

(51) Int. Cl. E05F 1/12

(52) U.S. Cl. CPC E05F 1/1223; E05Y 2201/11; E05Y 2201/41; E05Y 2201/484; E05Y 2201/499; E05Y 2900/132

(57) ABSTRACT

An adjustable self-closing hinge includes a frame leaf for mounting to a door frame, having a pair of eyelets defining a barrel space, a door leaf including a barrel dimensioned to be pivotal in the barrel space, a spring assembly in the barrel and including at least one torsion spring, each torsion spring having an adjustment end with a spring lug, at least one tightening pin located in the barrel, each tightening pin having a body with a forked end for engaging the respective spring lug, a set of aligned locking pin features closer to the forked end, and a set of adjustment features located farther from the forked end, the locking pin features aligned with the adjustment features; and at least one locking pin for securing a rotated position of the tightening pin by engaging one of the locking pin features and a pin hole in the barrel.

### BACKGROUND

The present invention relates generally to door assemblies of the type used in hospitals, nursing homes, clinics, schools, and other commercial facilities. More specifically, the present hinge assembly is designed for applications where it is desired to provide a force for closing a door while the same time reducing the chances of cords, wires and/or ropes or the like (hereinafter referred to as “ligatures”) being caught on the self-closing hinge.

A common design parameter for doorways in modern healthcare facilities, particularly psychiatric treatment facilities, is avoiding protruding fixtures that can be used to wrap a rope or rope-like construction around with which a patient can use to harm themselves. Door latches in such facilities are now designed specifically as “anti-ligature” to avoid presenting a tie-down anchoring location.

Besides the door knobs themselves, traditional commercial door closers, typically mounted at the top of the door with a spring or fluid-powered mechanism generating biasing force urging the door closed, have also been a subject location for patient-directed ligature anchoring. As such, since the doors to patient rooms in many such facilities need to be self-closing, both for patient health and for fire prevention, more recent door assembly designs have replaced the traditional closure mechanisms with hinges having internal spring mechanisms that are sufficiently powerful to close patient room doors or other facility doors as needed. In addition, these powered or self-closing hinges are designed with a smooth contour and outer profile to avoid being ligature anchor points.

A drawback of such internally biased or powered hinges, also referred to as self-closing hinges, is that the spring force for a given hinge is fixed at the factory during assembly. As such, the hinges are installed in a pre-tensioned condition, which makes it cumbersome for the installer to properly assemble. The doors for such facilities are often heavy, in the range of 150-600 lbs, so the assembly of self-closing hinges becomes a multi-installer operation, including man handling the door in place, and also attaching a pre-loaded hinge.

Another drawback of conventional self-closing hinges is that if the spring force set at the factory was too strong or too weak for a particular door size and weight, the hinge needs to be returned to the distributor or factory for replacement for a more suitable model. A still further design consideration of such self-closing hinges is whether the door is left or right opening. In some cases, selection of the improper hinge for the application requires return of the hinge to the respective distributor, delaying facility construction and adding to installation costs.

Thus, there is a need for an improved self-closing anti-ligature hinge for use in commercial and/or medical facilities that addresses the above-described needs.

### SUMMARY

The above-listed needs are met or exceeded by the present adjustable self-closing anti-ligature hinge which features an internal adjustment mechanism that allows the installer to set the spring closure force at the jobsite during installation. Thus, the hinge is shipped in an unloaded or unbiased condition, which facilitates original installation on the door. Then, once assembled, the installer can readily adjust the applied spring force using simple tools provided with the hinge, and following a relatively straightforward adjustment procedure. Accordingly, hinge installation is easily accomplished with a single installer, even when the door is relatively heavy.

Prior to mounting the hinge to the door, a cover plate is removed, as well as two locking pins. The locking pins are removed by threading a removal tool into a threaded socket of each pin and pulling the pin vertically from the hinge. Removal of the pins results in a release of tension on each of two tension springs within the hinge. Next, installation proceeds by installing the hinge to both the door frame and the door. A first hinge frame leaf portion is attached to the door frame and has eyelets for receiving end pins, and a space between the eyelets is dimensioned for pivotally accommodating a barrel of a second hinge door leaf portion, which is mounted to the door. The barrel encloses at least one and preferably two tension springs, as well as the present adjusting mechanism.

Included in the adjusting mechanism is a center block that separates a first tightening pin and a second tightening pin, each tightening pin having a forked end that engages a lug end of the respective torsion spring. Opposite ends of the springs are engaged by forked end pins that are fixed to the frame leaf in the respective eyelets.

Adjustment of the torsion spring tension is achieved by inserting a projecting rod of a tension tool into a corresponding adjustment feature of the respective tightening pin. After locking pins are removed, the tightening pin is rotated by the tension tool until a locking pin feature is aligned with a pin hole in the barrel. Next, the locking pin is inserted into the pin hole and the locking pin feature, to hold the spring in place. To increase the spring tension on each of the two torsion springs, the tension tool is inserted into the adjustment feature, then the locking pin is removed. The tension tool is then rotated in 90° increments to gradually axially wind the spring by rotating the tightening pin. Indicia on the tightening pin, preferably numbers 1 to 4, are stamped on the tightening pin so that the installer can see how much tension is placed on the spring. With each 90° increment of movement by the tension tool, the locking pin is inserted into the pin hole and the locking pin feature to hold the spring in that tension position. As the next position is needed, the installer then removes the locking pin and further rotates the tightening pin by inserting the projecting rod into the next adjustment feature. The locking pin is reinserted into both the pin hole in the barrel and the locking pin feature in the tightening pin to hold the desired spring tension.

Depending on the weight of the door, the present hinge is adjustable to provide increased force with increased door weight. For example, a 150 lb door is preferably set with a spring position of 3 of the tightening pin, after 180° rotation of the tightening pin. A 300 lb door is preferably set with a spring position of 4 of the tightening pin, after 360° rotation of the tightening pin. A 600 lb door is set by rotating the tightening pin 6 times from position 1, which is zero force, to a 540° position of rotation of the tightening pin at which the tightening pin shows a number 3 indicia again.

Once the desired amount of rotation or tensioning is achieved for each of the torsion springs, the locking pin is secured in both the pin hole and the locking pin feature, and the locking pin tool is disengaged from the pin, preferably by unthreading. Lastly, the cover plate is reinstalled by attachment to the center block, which separates the two tightening pins from each other.

More specifically, an adjustable self-closing hinge is provided, including a frame leaf configured for mounting to a door frame, and including a pair of axially separated eyelets defining a barrel space, a door leaf configured for mounting to a door and including a barrel dimensioned to be pivotally engaged in the barrel space, a spring assembly located in the barrel and including at least one torsion spring, each torsion spring having a fixed end secured to an end pin fixed in one of the eyelets, and an opposite adjustment end with a spring lug, at least one tightening pin located in the barrel, each tightening pin having a body with a forked end configured for engaging the respective spring lug, a set of aligned locking pin features closer to the forked end, and a set of adjustment features located farther on the body from the forked end, the locking pin features axially aligned with the adjustment features; and at least one locking pin configured for securing a rotated position of each tightening pin by engaging a corresponding one of the locking pin features and a pin hole in the barrel.

In an embodiment, the hinge includes a center block located in the barrel and axially separating first and second tightening pins. In an embodiment, also included on the hinge is a cover plate mountable on the barrel and engageable with the center block.

In another embodiment, the hinge includes a tension tool having a handle and a projecting rod extending from the handle and dimensioned for slidably engaging the adjustment features of each tightening pin.

In a preferred embodiment, the tension tool includes a pin tool secured in the handle and configured for engaging and removing the locking pin from the barrel. In an embodiment, the tension tool is configured such that upon engagement of the projecting rod into a corresponding one of the adjustment features, and upon removal of the locking pin from the locking pin feature, movement of the handle causes rotation of the tightening pin.

In an embodiment, each tightening pin is configured with four of the adjustment features mounted in 90° increments on the body. In a preferred embodiment, indicia are provided on the tightening pin for indicating a rotated position of the tightening pin relative to the barrel. In another embodiment, the hinge includes a washer mounted between the fixed end of the torsion spring and the end pin.

In an embodiment a method for adjusting the present adjustable self-closing hinge includes providing a tension tool having a handle and a projecting rod extending from the handle, the projecting rod dimensioned for slidably engaging the adjustment features of each tightening pin, the tension tool includes a pin tool secured in the handle and configured for engaging and removing the locking pin from the barrel, engaging the projecting rod in a selected one of the adjustment features, removing the locking pin from the barrel, rotating the tightening pin by manipulation of the tension tool to align a selected one of the locking pin features with the pin hole of the barrel, and inserting the locking pin into the locking pin feature and the pin hole to retain said tightening pin in position in the barrel to secure a desired spring tension.

In an embodiment, the method includes providing a cover plate on the barrel, and removing the cover plate prior to effecting the engagement of the tension tool with the tightening pin. In a preferred embodiment, the method includes providing a center block located in the barrel, the center block axially separating the first and second tightening pins, and replacing the cover plate on the barrel by fastening the cover plate to the center block.

In another embodiment, a method is provided for adjusting tension of an adjustable, self-closing hinge including a frame leaf configured for mounting to a door frame, and including a pair of axially separated eyelets defining a barrel space, a door leaf configured for mounting to a door and including a barrel dimensioned to be pivotally engaged in the barrel space, a spring assembly located in the barrel and including a pair of torsion springs, each torsion spring has a fixed end secured to an end pin fixed in one of the eyelets, and an opposite adjustment end with a spring lug, first and second tightening pins located in the barrel, each tightening pin having a body with a forked end configured for engaging the respective spring lug, a set of aligned locking pin features closer to the forked end, and a set of adjustment features located farther on the body from the forked end, the locking pin features axially aligned with the adjustment features, and a pair of locking pins configured for securing a rotated position of each tightening pin by engaging a corresponding one of the locking pin features and a pin hole in the barrel, providing a tension tool having a handle and a projecting rod extending from the handle, the projecting rod dimensioned for slidably engaging the adjustment features of the tightening pins, the tension tool includes a pin tool secured in the handle and configured for engaging and removing the locking pins from the barrel, the method includes engaging the projecting rod in a selected one of the adjustment features, removing the locking pin from the barrel using the pin tool, rotating the tightening pin by manipulation of the tension tool to align a selected one of the locking pin features with the pin hole of the barrel, with the pin tool, inserting the locking pin into the locking pin feature and the pin hole to retain the tightening pin in position in the barrel, further engagement of the projecting rod into another of the adjustment features, removal of the locking pin from the locking pin feature and the pin hole using the pin tool, rotation of the tightening pin using the tension tool to achieve a desired spring tension, and insertion of the locking pin into the locking pin feature and the pin hole to secure a desired spring tension.

In an embodiment, the method includes repeating the engagement of the projecting rod into a selected one of the adjustment features, removal of the locking pin from the locking pin feature and the pin hole, and rotation of the tightening pin using the tension tool until a desired spring tension is achieved.

In an embodiment, the method further includes providing the adjustment features at 90° increments on the tightening pin body, and rotating the tightening pin 180° for mounting a 150 lb door, 360° for mounting a 300 lb door and 540° for mounting a 600 lb door.

In an embodiment, the method further includes providing indicia on the tightening pin body for designating a rotational position of the tightening pin relative to the barrel.

In still another embodiment, an adjustable, self-closing hinge includes a frame leaf configured for mounting to a door frame, and including a pair of axially separated eyelets defining a barrel space, a door leaf configured for mounting to a door and including a barrel dimensioned to be pivotally engaged in the barrel space, the barrel provided with a removable cover plate, a spring assembly located in the barrel and including a pair of torsion springs, each torsion spring having a fixed end secured to an end pin fixed in one of the eyelets, and an opposite adjustment end with a spring lug, first and second tightening pins located in the barrel, each tightening pin having a body with a forked end configured for engaging the respective spring lug, and a set of aligned locking pin features closer to the forked end, and a set of adjustment features located farther on the body from the forked end, the locking pin features axially aligned with the adjustment features, a pair of locking pins configured for securing a rotated position of each tightening pin by engaging a corresponding one of the locking pin features and a pin hole in the barrel, and a center block located in the barrel and axially separating the first and second tightening pins, the cover plate being attachable to the center block.

### BRIEF DESCRIPTION OF THE DRAWINGS

FIG. 1 is a front view of the present self-closing hinge installed on a door in a door frame;

FIG. 2 is an exploded perspective view of a prior art self-closing, anti-ligature hinge;

FIG. 3 is an exploded perspective view of the present self-closing hinge with installation tool;

FIG. 4 is a top perspective view of a tightening pin used in the present self-closing hinge;

FIG. 5 is an end view of the frame leaf of the present hinge;

FIG. 6 is a perspective view of an end pin used in the present self-closing hinge;

FIG. 7 is a side view of the center block of the present self-closing hinge;

FIG. 8 is a top view of the installation tool provided with the present self-closing hinge;

FIG. 9 is a top view of the pin tool of FIG. 3;

FIG. 10 is a front perspective view of a first step in the installation of the present self-closing hinge;

FIG. 11 is a front perspective view of a second step in the installation of the present self-closing hinge;

FIG. 12 is a front perspective view of a third step in the installation of the present self-closing hinge;

FIG. 13 is a front perspective view of a fifth step in the installation of the present self-closing hinge;

FIG. 14 is a front perspective view of a fourth step in the installation of the present self-closing hinge; and

FIG. 15 is a fragmentary exploded perspective view of an alternate embodiment to the hinge of FIG. 3.

### DETAILED DESCRIPTION

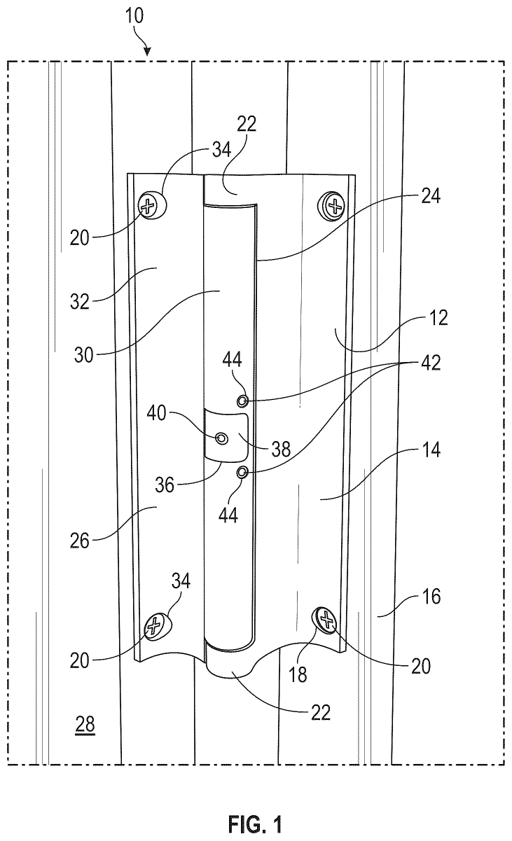

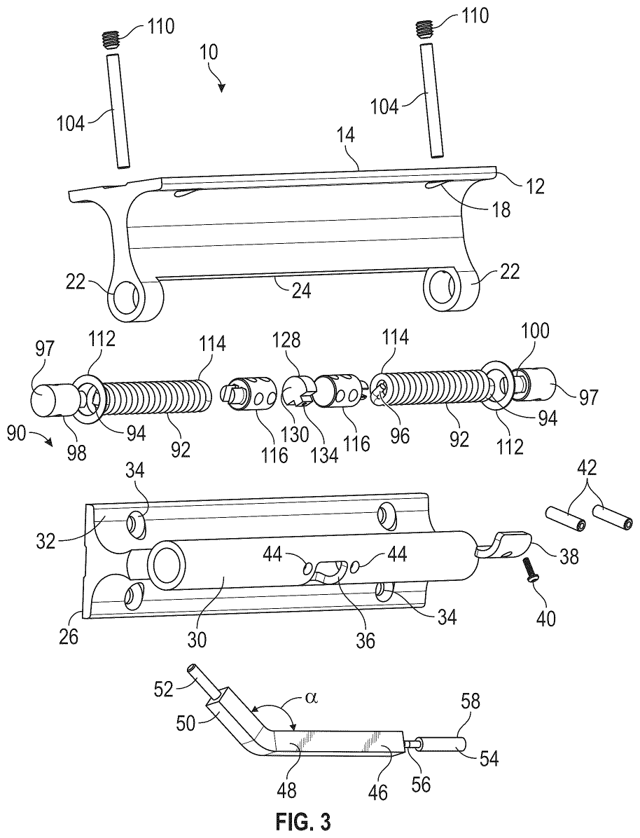

Referring now to FIGS. 1 and 3, the present, adjustable, self-closing hinge is generally designated 10, and includes a frame leaf 12 including a base 14 configured for mounting to a door frame 16. As is known in the art, the base 14 is provided with a plurality of mounting openings 18 accommodating fasteners such as screws 20 for securing the leaf 12 in place on the door frame 16. Included on the frame leaf 12 is a pair of axially separated eyelets 22 defining a barrel space 24 therebetween.

Also included on the hinge 10 is a door leaf 26 configured for mounting to a door 28 and including a cylindrical, hollow or tubular barrel 30 dimensioned to be pivotally engaged in the barrel space 24. As is the case with the frame leaf 12, the door leaf 26 has a base 32 configured for engaging the door 28 and including a plurality of mounting openings 34 configured for accommodating fasteners such as screws 20. Included on the barrel 30 is a cover plate opening 36 accommodating a removable cover plate 38 secured in place using a fastener 40. Also seen in FIGS. 1 and 3 are at least one and preferably a pair of locking pins 42 located in pin holes 44 in the barrel 30. It will be seen from FIG. 1 that the profile of the present hinge 10 is streamlined and provides spring force for closing the door 28 without providing attachment points for ligature.

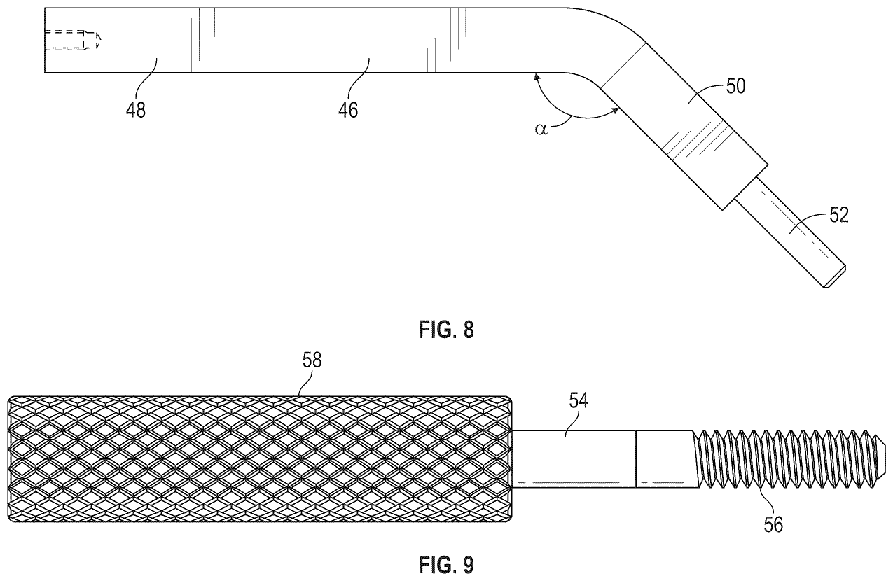

Referring now to FIGS. 3, 8 and 9, preferably included with the hinge 10 is a tension tool 46 having a handle 48 and with an angled end 50 having a projecting rod 52 extending from the handle. Opposite the projecting rod 52 is a removable pin tool 54 secured in the handle 48, as by being threaded or the like, and having a working end 56 configured for engaging and removing the locking pins 42 from the barrel 30. In a preferred embodiment, the pin tool 54 also has a handle 58 which preferably has a grip enhancing surface, for example knurled or the like (FIG. 9). While other angles are contemplated, the angled end 50 of the tension tool 46 defines an angle α of 30-40° (FIG. 8).

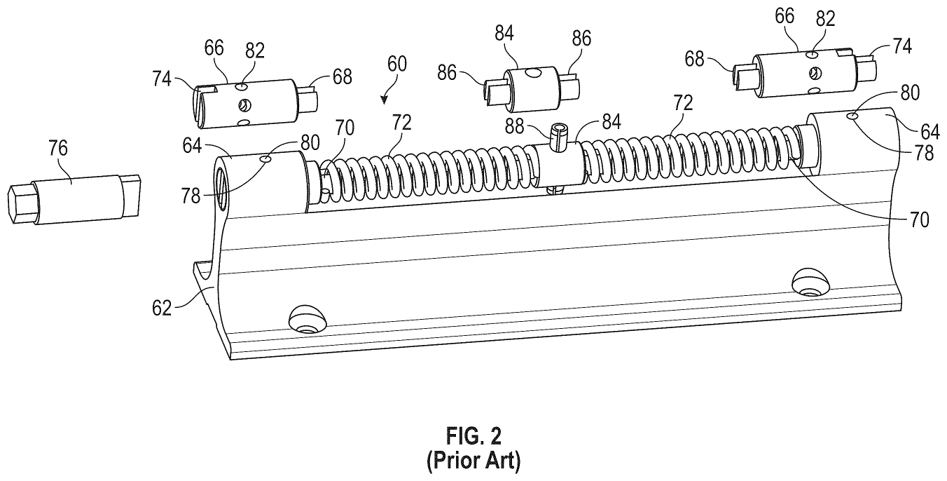

Referring now to FIG. 2, a prior art self-closing hinge is generally designated 60. A frame leaf 62 has a pair of spaced barrels 64 configured for accommodating end pins 66. The end pins 66 are each forked at one end 68 to engage an end 70 of a torsion spring 72. There are two such springs 72 in the hinge 60. A slotted end 74 of each end pin 66 accommodates a tool 76 such as a screw driver to rotate the end pin and thus adjust by rotation the tension on the spring 72. Once adjusted, the end pin 66 is held in place by a locking pin 78 that passes through a corresponding opening 80 in the barrel 64 and a complementary opening 82 in the end pin. Opposite the end pins 66, the springs 72 are secured by a central pin 84 with forked ends 86 for engaging opposite ends of the springs 72. The central pin 84 is fixed in place by a locking pin 88 that engages the frame leaf, and as such the spring ends are also fixed in place. While not shown here, the springs 72 are held within a barrel of a door leaf similar in construction to the door leaf 26 and which is pivotable relative to the frame leaf 62.

A problem with the hinge 60 is that the tension of the springs 72 is adjusted at the factory, and arrives at the installation site in a biased or loaded condition. Adjustment of the spring tension involves using both of the end pins 66, which is impossible after installation on the door and frame. Spring tension or torque adjustment needs to be accomplished with the hinge dismounted from the door and frame. It is cumbersome for the installers to install the door in the door frame with the preloaded hinge, and also as described above, the tension may not be appropriate for the specific door being installed. Thus, the hinge in many cases needs to be returned to the distributor or manufacturer for replacement of a more appropriate model.

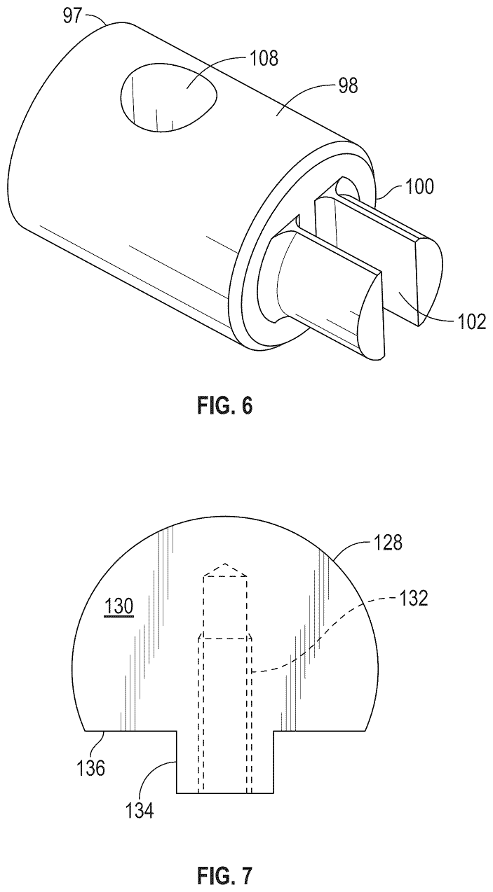

Referring now to FIGS. 3 and 4-7, included in the present hinge 10 is a spring assembly, generally designated 90, located in the barrel 30. At least one, and preferably a pair of torsion springs 92 each have a fixed end 94 secured to an end pin 96 which in turn is fixed in one of the eyelets 22 on the frame leaf 12. As is the case with the torsion springs 72 in the hinge 60, each of the torsion springs 92 has a radially projecting end lug 96 at each end. The end pin 97 (FIG. 6) has a cylindrical body 98 from which projects a forked end 100 defining a space 102 for accommodating the end lug 96. Fixing the body 98 in the eyelet 22 is achieved by an eyelet pin 104 passing through a passage 106 (FIG. 5) in the frame leaf 12 and engaging a throughbore 108 in the end pin body 98. A fastener 110, such as a setscrew, secures the eyelet pin 104 in place. Preferably, a flat washer 112 is disposed between the spring fixed end 94 and the eyelet 22 to reduce rotational friction between the barrels 30 and the eyelets.

Referring now to FIGS. 3 and 6, opposite the fixed end 94, each torsion spring 92 has an adjustment end 114 with a radially projecting end lug 96 like the fixed end. At least one and preferably two tightening pins 116, each associated with a corresponding torsion spring 92, each have a cylindrical body 118 from which projects a forked end 120 configured for accommodating the end lug 96 of the adjustment end 114. As such, axial rotation of the tightening pin 116 will cause the torsion spring 92 to twist axially and thus adjust the amount of spring force exerted by the torsion spring.

Also included on the body 118 of the tightening pin 116 is a set of locking pin features 122 close to the forked end 120. In the preferred embodiment, there are four locking pin features 122 on each body 118, the features, preferably holes being spaced 90° apart. However, the number and positioning of the locking pin features 122 may vary to suit the application. In the preferred embodiment, the locking pin features 122 are each dimensioned to slidingly accommodate one of the locking pins 42. Next to the locking pin features 122 is a like plurality of adjustment features 124, located farther on the body 118 from the forked end 120. Thus, preferably, there are four of the adjustment features 124, preferably holes, mounted in 90° increments. As is the case with the locking pin features 122, the number and spacing of the adjustment features 124 is variable depending on the application.

It is preferred that the locking pin features 122 are axially aligned with the adjustment features 124. Also, the adjustment features 124 are dimensioned for slidingly accommodating the projecting rod 52 of the tension tool 46. While in the preferred embodiment, the diameter of the locking pin features 122 and the adjustment features 124 are similar or even identical, it is contemplated that the dimensions may vary to suit the application. Opposite the forked end 120, the cylindrical body 118 has a planar end 126. Once the hinge 10 is assembled, the locking pins 42 each pass through one of the pin holes 44 in the barrel 30 and a selected one of the locking pin features 122 to maintain the desired spring tension.

Referring now to FIGS. 3 and 7, preferably centrally located in the spring assembly 90 between the tightening pins 116 is a center block 128 dimensioned to fit within the barrel 30 and having generally planar sides 130 for sliding engagement with the planar ends 126 of the tightening pins 116. A main function of the center block 128, besides spacing the tightening pins 116 and providing structural integrity, is to provide a mounting point for the cover plate 38. In the preferred embodiment, this mounting point takes the form of a threaded bore 132 with an open end in a boss 134 projecting from a front end 136. The cover plate fastener 40 secures the cover plate 38 to the center block 128. As seen in FIG. 7, the center block 128 is generally “D”-shaped when viewed from the side.

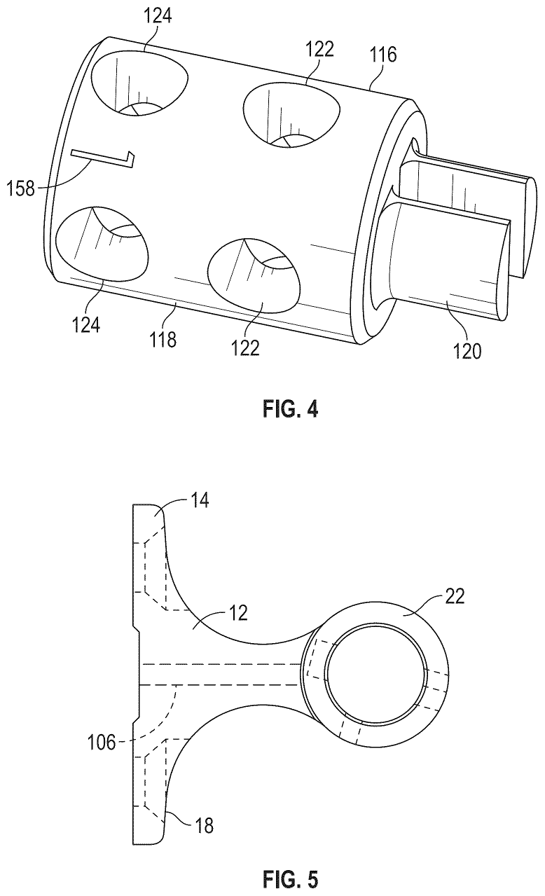

Referring again to FIG. 4, another feature of the tightening pins 116 is user-visible indicia 138 placed on the cylindrical body 118 between the adjustment features 124. As such, in a preferred embodiment, the indicia 138 are numbered “1”, “2”, “3” and “4”. The purpose of the indicia 138 is for indicating a rotated position of the tightening pin 116 relative to the barrel 30 as discussed in more detail below.

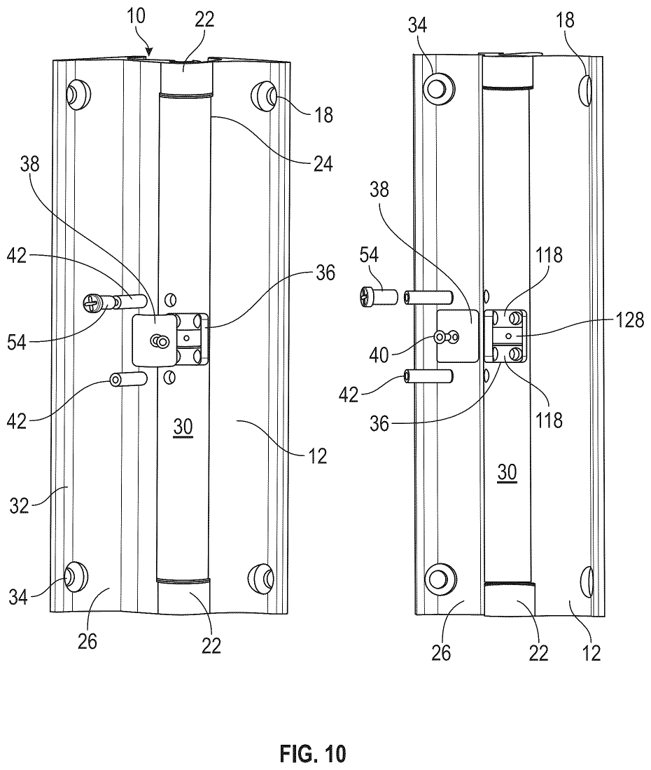

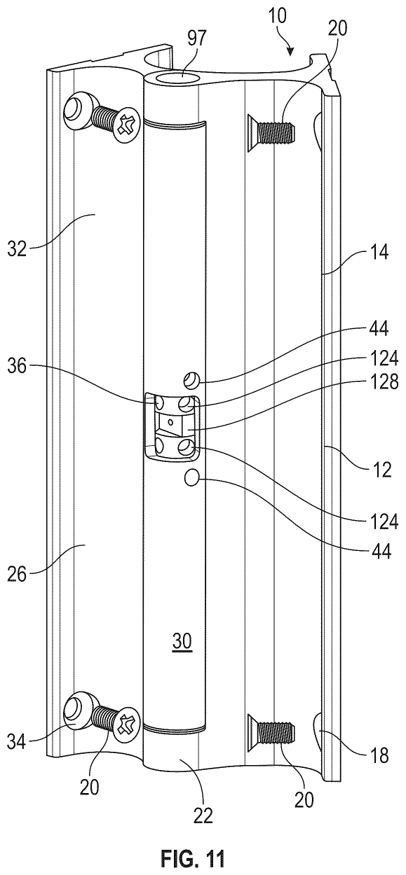

Referring now to FIGS. 1, 10 and 11, the installation of the hinge 10 at a jobsite will be described. First, the cover plate 38 is removed by releasing the cover plate fastener. Once the cover plate 38 is removed, the center block 128 and the adjustment features 124 of each tightening pin 116 are exposed. Then, the pin tool 54 (schematically shown as a fastener) is used to remove each of the locking pins 42. Removal of the locking pins 42 allows the torsion springs 92 to fully relax, with no tension exerted on the hinge leaves 12, 26. Referring now to FIG. 11, at this stage, the hinge leaves 12, 26 are mounted to the door frame 16 and to the door 28, as known in the art.

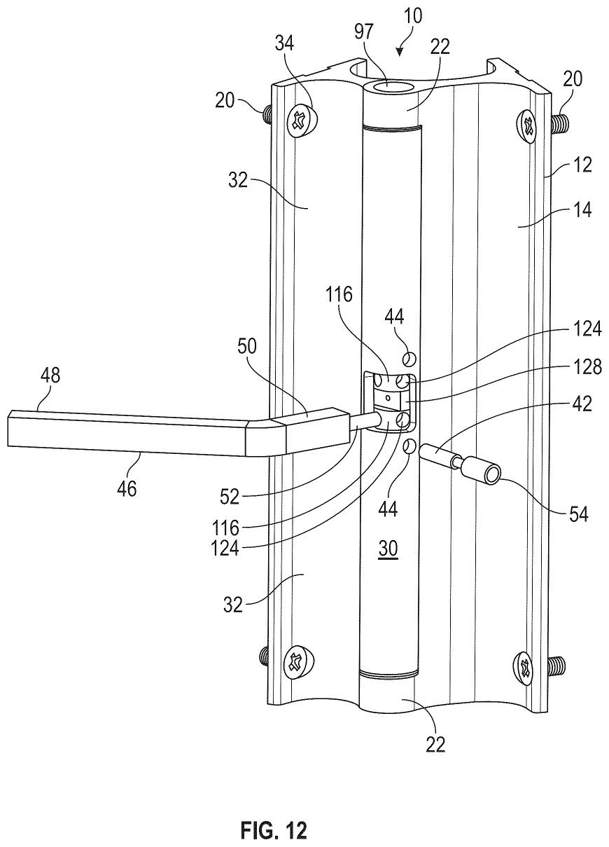

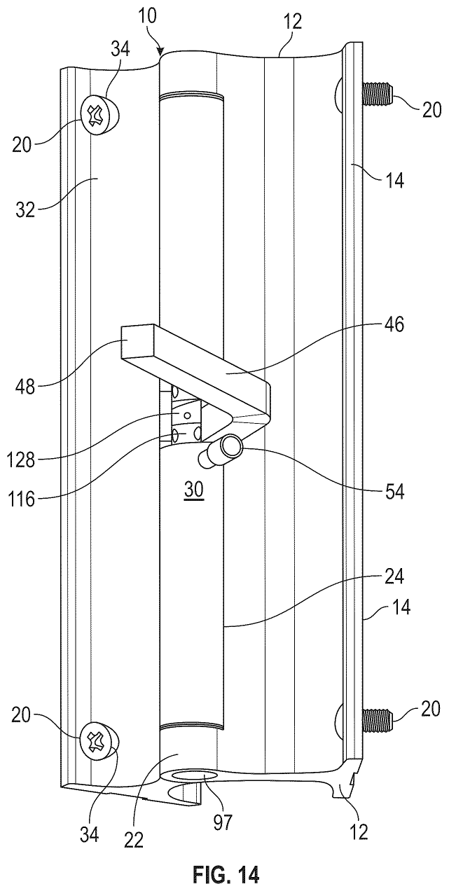

Referring now to FIGS. 12 and 14, using the tension tool 46, the projecting rod 52 is inserted into one of the adjustment features 124, preferably the one nearest the door leaf base 32. The tension tool 46 is manipulated to rotate the tightening pin 116 so that the corresponding locking pin feature 122 corresponding to the engaged adjustment feature 124 is aligned with the pin hole 44. This rotation will begin to increase tension on the torsion spring 92. At the completion of this movement, the tension tool 46 is in the position seen in FIG. 14. Next, using the pin tool 54, the locking pin 42 is inserted into both the pin hole 44 and the locking pin feature 122. Once the locking pin 42 is in place, the spring tension is secured.

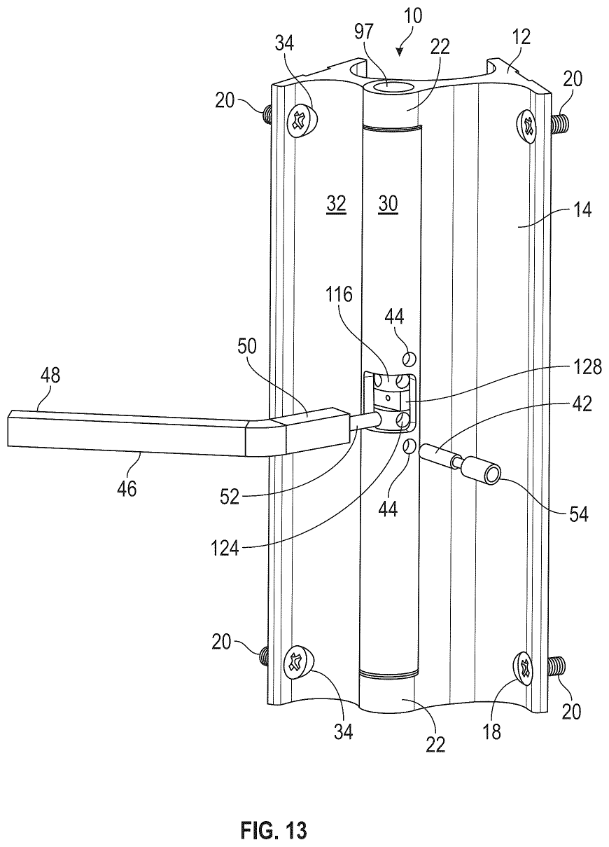

Referring now to FIG. 13, as more spring tension is desired, the tension tool 46 is then inserted into the next available adjustment feature 124. Next, using the pin tool 54, the locking pin 42 is removed. Then, the above-described rotational movement of the tightening pin 116 is repeated to further increase the tension on the torsion spring 92. Once the tension tool 46 reaches the position of FIG. 14, the pin tool 54 is used to replace the locking pins by insertion into both the pin hole 44 and the locking pin feature 122. At this point, a different indicia 136 is visible on the tightening pin. 116. This process is repeated until the desired spring tension is achieved. Then the process is repeated for the other torsion spring 92 in the spring assembly, using the other tightening pin 116.

Depending on the weight of the door 28, the present hinge 10 is adjustable to provide increased force with increased door weight. For example, a 150 lb door is preferably set with a spring position of 3 of the tightening pin 116, after 180° rotation of the tightening pin. A 300 lb door is preferably set with a spring position of 4 of the tightening pin 116, after 360° rotation of the tightening pin. A 600 lb door is set by rotating the tightening pin 6 times from position 1, which is zero force, to a 540° position of rotation of the tightening pin at which the tightening pin shows a number 3 indicia again. Once the desired spring tension is achieved, the user fully inserts the locking pins 42 into both the pin hole 44 and the locking pin feature 122 using the pin tool 54, and the cover plate 38 is reinstalled into the cover plate opening 36 using the cover plate fastener 40 which engages the center block 128.

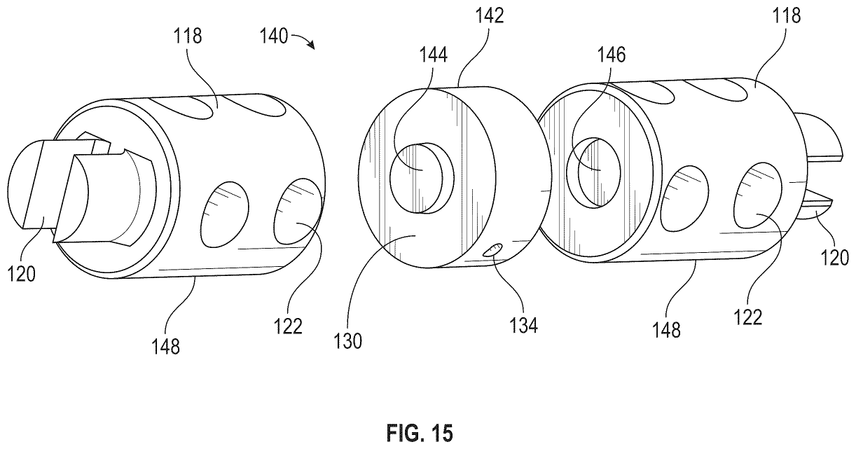

Referring now to FIGS. 3 and 15, an alternate embodiment of the hinge 10 is generally designated 140. Components shared with the hinge 10 are indicated with identical reference numbers. A main difference between the hinges 10 and 140 is that in the latter, the center block 142 is modified to have two, laterally-extending locator bosses 144. These bosses 144 are rotatably received in complementary locator recesses 146 in each of two tightening pins 148, otherwise similar to the tightening pins 116. While the hinge 140 as depicted shows the bosses 144 on the center block 142 and the recesses 146 on the tightening pins 148, it is contemplated that this arrangement can be reversed. Upon assembly of the hinge 140, the center block is more positively located between the tightening pins, and relative rotation of the components as described above is facilitated.

While a particular embodiment of the present adjustable self-closing anti-ligature hinge has been described herein, it will be appreciated by those skilled in the art that changes and modifications may be made thereto without departing from the invention in its broader aspects and as set forth in the following claims.

1. An adjustable, self-closing hinge, comprising:
a frame leaf configured for mounting to a door frame, and including a pair of axially separated eyelets defining a barrel space;
a door leaf configured for mounting to a door and including a barrel dimensioned to be pivotally engaged in said barrel space;
a spring assembly located in said barrel and including at least one torsion spring, each said torsion spring having a fixed end secured to an end pin fixed in one of said eyelets, and an opposite adjustment end with a spring lug;
at least one tightening pin located in said barrel, each said tightening pin having a body with a forked end configured for engaging the respective spring lug, and a set of aligned locking pin features closer to the forked end, and a set of adjustment features located farther on the body from the forked end, said locking pin features axially aligned with said adjustment features; and
at least one locking pin configured for securing a rotated position of each said tightening pin by engaging a corresponding one of said locking pin features and a pin hole in said barrel.

2. The adjustable, self-closing hinge of claim 1, further including a center block located in said barrel and axially separating first and second of said at least one tightening pins.

3. The adjustable self-closing hinge of claim 2, further including a cover plate mountable on said barrel and engageable with said center block.

4. The adjustable self-closing hinge of claim 1, further including a tension tool having a handle and a projecting rod extending from said handle and dimensioned for slidably engaging said adjustment features of each said tightening pin.

5. The adjustable self-closing hinge of claim 4, wherein said tension tool includes a pin tool secured in said handle and configured for engaging and removing each said locking pin from said barrel.

6. The adjustable self-closing hinge of claim 5, wherein said tension tool is configured such that upon engagement of said projecting rod into a corresponding one of said adjustment features, and upon removal of said locking pin from said locking pin feature, movement of said handle causes rotation of said tightening pin.

7. The adjustable self-closing hinge of claim 1, wherein each said tightening pin is configured with four of said adjustment features mounted in 90° increments.

8. The adjustable self-closing hinge of claim 1, further including indicia on each said tightening pin for indicating a rotated position of said tightening pin relative to said barrel.

9. The adjustable self-closing hinge of claim 1, further including a washer mounted between said fixed end of said torsion spring and said end pin.

10. A method for adjusting the adjustable self-closing hinge of claim 1, including:
providing a tension tool having a handle and a projecting rod extending from said handle, said projecting rod dimensioned for slidably engaging said adjustment features of each said tightening pin, said tension tool includes a pin tool secured in said handle and configured for engaging and removing each said locking pin from said barrel;
engaging said projecting rod in a selected one of said adjustment features;
removing said locking pin from said barrel;
rotating said tightening pin by manipulation of said tension tool to align a selected one of said locking pin features with said pin hole of said barrel; and
inserting said locking pin into said locking pin feature and said pin hole to retain said tightening pin in position in said barrel to secure a desired spring tension.

11. The method of claim 10, further including providing a cover plate on said barrel, and removing said cover plate prior to effecting said engagement of said tension tool with said tightening pin.

12. The method of claim 11 further including providing a center block located in said barrel, said center block axially separating first and second of said at least one tightening pin, and replacing said cover plate on said barrel by fastening said cover plate to said center block.

13. A method of adjusting tension of an adjustable, self-closing hinge, said hinge including a frame leaf configured for mounting to a door frame, and including a pair of axially separated eyelets defining a barrel space, a door leaf configured for mounting to a door and including a barrel dimensioned to be pivotally engaged in said barrel space, a spring assembly located in said barrel and including a pair of torsion springs, each said torsion spring having a fixed end secured to an end pin fixed in one of said eyelets, and an opposite adjustment end with a spring lug, first and second tightening pins located in said barrel, each said tightening pin having a body with a forked end configured for engaging the respective spring lug, a set of aligned locking pin features closer to the forked end, and a set of adjustment features located farther on the body from the forked end, said locking pin features axially aligned with said adjustment features, and a pair of locking pins configured for securing a rotated position of each said tightening pin by engaging a corresponding one of said locking pin features and a pin hole in said barrel, providing a tension tool having a handle and a projecting rod extending from said handle, said projecting rod dimensioned for slidably engaging said adjustment features of said tightening pins, said tension tool includes a pin tool secured in said handle and configured for engaging and removing said locking pins from said barrel, said method comprising:
engaging said projecting rod in a selected one of said adjustment features;
removing said locking pin from said barrel using said pin tool;
rotating said tightening pin by manipulation of said tension tool to align a selected one of said locking pin features with said pin hole of said barrel;
with said pin tool, inserting said locking pin into said locking pin feature and said pin hole to retain said tightening pin in position in said barrel;
further engagement of said projecting rod into another of said adjustment features;
removal of said locking pin from said locking pin feature and said pin hole using said pin tool;
rotation of said tightening pin using said tension tool to achieve a desired spring tension; and
insertion of said locking pin into said locking pin feature and said pin hole to secure a desired spring tension.

14. The method of claim 13, further including repeating said engagement of said projecting rod into a selected one of said adjustment features, removal of said locking pin from said locking pin feature and said pin hole, and rotation of said tightening pin using said tension tool until a desired spring tension is achieved.

15. The method of claim 13, further including providing said adjustment features at 90° increments on said tightening pin body, and rotating said tightening pin 180° for mounting a 150 lb door, 360° for mounting a 300 lb door and 540° for mounting a 600 lb door.

16. The method of claim 13, further including providing indicia on said tightening pin body for designating a rotational position of said tightening pin relative to said barrel.

17. An adjustable, self-closing hinge, comprising:
a frame leaf configured for mounting to a door frame, and including a pair of axially separated eyelets defining a barrel space;
a door leaf configured for mounting to a door and including a barrel dimensioned to be pivotally engaged in said barrel space, said barrel provided with a removable cover plate;
a spring assembly located in said barrel and including a pair of torsion springs, each said torsion spring having a fixed end secured to an end pin fixed in one of said eyelets, and an opposite adjustment end with a spring lug;
first and second tightening pins located in said barrel, each said tightening pin having a body with a forked end configured for engaging the respective spring lug, and a set of aligned locking pin features closer to the forked end, and a set of adjustment features located farther on the body from the forked end, said locking pin features axially aligned with said adjustment features;
a pair of locking pins configured for securing a rotated position of each said tightening pin by engaging a corresponding one of said locking pin features and a pin hole in said barrel; and
a center block located in said barrel and axially separating said first and second tightening pins, said cover plate being attachable to said center block.

18. The adjustable self-closing hinge of claim 17, further including a tension tool having a handle and a projecting rod extending from said handle and dimensioned for slidably engaging said adjustment features of said tightening pins, said tension tool includes a pin tool secured in said handle and configured for engaging and removing said locking pins from said barrel.

19. The adjustable self-closing hinge of claim 18, wherein said tension tool is configured such that upon engagement of said projecting rod into a corresponding one of said adjustment features, and upon removal of said locking pin from said locking pin feature, movement of said handle causes rotation of said tightening pin.

20. The adjustable self-closing hinge of claim 17, further including indicia on said tightening pins for indicating a rotated position of said tightening pin relative to said barrel, and a washer mounted between said fixed end of said torsion spring and said end pin.
